(19) United States
(12) Patent Application Publication
(10) Pub. No.: US 2021/0132282 A1
(43) Pub. Date: May 6, 2021

(54) BACKLIGHT MODULE AND DISPLAY DEVICE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventors: Fangfang WU, Beijing (CN); Zhen ZHANG, Beijing (CN); Jinfeng ZHANG, Beijing (CN); Haifeng XU, Beijing (CN)

(73) Assignees: HEFEI XINSHENG OPTOELECTRONICS TECHNOLOGY CO., LTD., Hefei, Anhui (CN); BOE TECHNOLOGY GROUP CO., LTD., Beijing (CN)

(21) Appl. No.: 16/640,171

(22) PCT Filed: May 7, 2019
(86) PCT No.: PCT/CN2019/085807

§ 371 Date: Feb. 19, 2020

(30) Foreign Application Priority Data
May 21, 2018 (CN) 201810487821.0

(51) Int. Cl. F21V 8/00

(52) U.S. Cl. CPC G02B 6/0025; G02B 6/004; G02B 6/0073; G02B 6/0031

(57) ABSTRACT

Provided is a backlight module and a display device. The backlight module includes a first optical structure provided in the first region of the light entering surface of the light guide plate and a plurality of second regions each located between two adjacent first regions. The first optical structure is configured to enable a part of light emitted by a corresponding light source to enter an inside of the light guide plate and reflect a part of light to the lamp bar. The second optical structure is configured to reflect light reaching the second optical structure back to the light entering surface of the light guide plate.

### CROSS-REFERENCE TO RELATED APPLICATION

This application claims a priority to Chinese Patent Application No. 201810487821.0 filed on May 21, 2018, the disclosures of which are incorporated in their entirety by reference herein.

### TECHNICAL FIELD

The present disclosure relates to the field of the production of liquid crystal products, in particular, to a backlight module and a display device.

### BACKGROUND

The light source in the backlight module is a light emitting diode (LED) lamp bar, and the ray emitting from the LED has a specific emission angle.

### SUMMARY

A backlight module, including a light guide plate and a lamp bar arranged on a light entering surface of the light guide plate, in which the lamp bar includes a circuit board and a plurality of light sources arranged at intervals on the circuit board, the light entering surface of the light guide plate includes a plurality of first regions and a plurality of second regions each located between two adjacent first regions, and the plurality of first regions is directly opposite to the plurality of light sources respectively, in which each of the plurality of first regions includes a first optical structure, the first optical structure being configured to enable a part of light emitted by a corresponding light source enter an inside of the light guide plate and reflect a part of light emitted by a corresponding light source to the lamp bar; and the circuit board includes a second optical structure located between two adjacent light sources, the second optical structure being configured to reflect light reaching the second optical structure back to the light entering surface of the light guide plate.

In some embodiments of the present disclosure, the second optical structure includes a diffusion layer, and the diffusion layer is configured to scatter the light reaching the second optical structure.

In some embodiments of the present disclosure, the diffusion layer comprises scattering particles arranged on the circuit board.

In some embodiments of the present disclosure, each of the plurality of light sources includes a light emitting diode (LED) lamp and a packaging layer covering an outside of the LED lamp, and an outside of the packaging layer includes a reflective layer configured to reflect light reaching the plurality of light sources back to the light guide plate.

In some embodiments of the present disclosure, the first optical structure comprises a metal film layer, and the metal film layer covers a part of each of the plurality of first regions.

In some embodiments of the present disclosure, an area of the plurality of first regions covered by the metal film layer is half of an area of the plurality of first regions.

In some embodiments of the present disclosure, the first optical structure comprises metal particles distributed at intervals between the two adjacent first regions.

In some embodiments of the present disclosure, the metal particles are formed in each of the plurality of first regions by a sputtering process.

In some embodiments of the present disclosure, a material of the metal particles is aluminum or silver.

In some embodiments of the present disclosure, an area of the plurality of first regions covered by the metal particles is half of an area of the plurality of first regions.

In some embodiments of the present disclosure, the first optical structure includes a groove arranged in the plurality of first regions and a transparent filler, in which the transparent filler is filled inside the groove and has air bubbles.

In some embodiments of the present disclosure, a material of the transparent filler is polyethylene terephthalate (PET), polymethyl methacrylate (PMMA), or methyl methacrylate (MS).

In some embodiments of the present disclosure, a light exiting surface of the light guide plate is arranged adjacent to the light entering surface, and a side surface of the light guide plate arranged opposite to the light exiting surface includes grid points, in which the grid points are configured to scatter light.

The present disclosure also provides a display device including any one of the above-mentioned backlight modules.

### BRIEF DESCRIPTION OF THE DRAWINGS

FIG. 1 is a schematic view showing a backlight module according to some embodiments of the present disclosure;

FIG. 2 is a schematic view showing a lamp bar according to some embodiments of the present disclosure;

FIG. 3 is a schematic view showing a light guide plate according to some embodiments of the present disclosure;

FIG. 4 is a schematic view showing a light guide plate according to another embodiments of the present disclosure; and

FIG. 5 is a schematic view showing a principle of a light path of light propagating on a bubble surface according to some embodiments of the present disclosure.

### DETAILED DESCRIPTION

The features and principles of the present disclosure will be described in detail below in conjunction with drawings. The embodiments cited are merely used for explaining the present disclosure, rather than limiting the protection scope of the present disclosure.

Since the maximum angle between two light rays in LED light is less than 180°, there will be a place where the light rays cannot reach in both side of the LED, that is, a dark region. The dark regions between two adjacent LEDs overlap each other, and the brightness of the overlapped regions is significantly lower than that of the regions illuminated by the LED light, so that bright and dark spots is observed by the human eyes. This phenomenon is called the hotspot phenomenon.

As shown in FIGS. 1 to 5, some embodiments of the present disclosure provide a backlight module. The backlight module includes a light guide plate 1 and a lamp bar arranged on a light entering surface of the light guide plate 2.

The lamp bar 2 includes a circuit board 23 and a plurality of light sources 21 arranged at intervals on the circuit board 23. The light entering surface of the light guide plate 1 includes a plurality of first light regions that is directly opposite the plurality of light sources 21 respectively, and a plurality of second regions between two adjacent first regions. Each of the plurality of first regions is provided with a first optical structure 11, so that a part of light emitted by a corresponding light source 21 is incident into an inside of the light guide plate 1, and a part of the light emitted by a corresponding light source 21 is reflected to the lamp bar 2.

The circuit board 23 includes a second optical structure 22 located between two adjacent light sources 21. The second optical structure 22 is configured to reflect light reaching the second optical structure 22 back to the light entering surface of the light guide plate 21.

In some embodiments, due to the limitation of the angle of the light rays emitted by the plurality of light sources 21, each of the plurality of first regions is a bright region and the second region is a dark region.

In the above embodiment, the first optical structure 11 reflects a part of light emitted by the plurality of light sources 21 to the lamp bar 2, thereby reducing the brightness of the first regions; and the second optical structure 22 reflects the part of light reflected by the first optical structure 11 to the light guide plate 1 again. Since the second optical structure 22 is located directly opposite the second region, at least a part of the light is reflected to the second region, thereby increasing the brightness of the second region. As a result, the difference in brightness between different regions of the light entering surface of the light guide plate 1 is reduced, the difference in light ratio between different regions is reduced, and thereby the occurrence of the hotspot phenomenon is avoided.

In some embodiments of the present disclosure, the second optical structure 22 includes a diffusion layer, so as to scatter the light reaching the second optical structure 22.

The arrangement of the diffusion layer prevents the light reflected by the second optical structure 22 from being emitted intensively, thereby increasing the light irradiation area and avoiding the occurrence of the hotspot phenomenon.

There are various structures of the diffusion layer. In some embodiments of the present disclosure, the diffusion layer comprises scattering particles arranged on the circuit board.

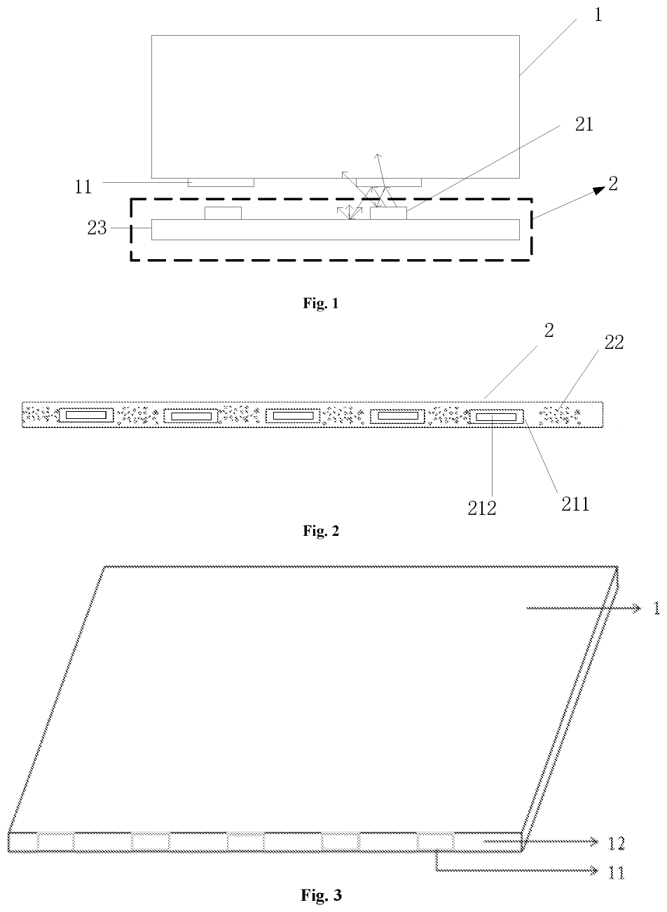

As shown in FIG. 2, in some embodiments of the present disclosure, the plurality of light sources 21 includes an LED lamp 212 and a packaging layer 211 covering an outside of the LED lamp 212, and an outside of the packaging layer 211 includes a reflective layer configured to reflect light reaching the plurality of light sources 21 back to the light guide plate 1.

In some embodiments of the present disclosure, the packaging layer 211 is made of a reflective material, and thus the packaging layer 211 is the reflective layer.

Since the packaging layer 211 is the reflective layer, there is no need to separately provide a reflective layer again, thereby simplifying the structure.

A part of the light emitted by the plurality of light sources 21 is reflected back to the lamp bar 2 by the first optical structure 11. In the light reflected by the first optical structure 11, a part of light incident to the second optical structure 22 is reflected to the light guide plate 1, and a part of the light incident to the plurality of light sources 21 is also reflected back to the light guide plate 1 through the arrangement of the reflective layer, thereby reducing the light loss.

There are various structural forms and manufacturing processes for the first optical structure 11.

In some embodiments of the present disclosure, as shown in FIG. 3, the first optical structure 11 is a metal film layer covering a part of the plurality of first regions.

In some embodiments, the first optical structure 11 is metal particles distributed at intervals in the plurality of first regions.

In some embodiments of the present disclosure, the first optical structure 11 is metal particles distributed at intervals in the plurality of first regions.

The arrangement of the metal particles is set according to actual needs, for example, the metal particles are uniformly distributed in the first regions or arranged in the first regions according to a certain rule, or randomly scattered in the first regions.

In some embodiments of the present disclosure, the metal particles are formed on the plurality of first regions by a sputtering process.

In some embodiments, a material of the metal particles is aluminum or silver.

Aluminum or silver metal material is hit by a high-pressure inert gas ionized by a sputtering process, so as to be sputtered to a predetermined position of the light guide plate 1 to form the first optical structure 11.

In the above embodiment of the present disclosure, in order to realize that after the light emitted by the light source 21 passes through the first optical structure 11, a part of the light enters the light guide plate 1 and a part of the light is reflected back to the lamp bar 2, the metal film layer or the metal particles cover a part of the first regions, and the area of the plurality of first regions covered by the metal film layer or the metal particles is set according to actual needs.

In some embodiments of the present disclosure, an area of the plurality of first regions covered by the metal film layer or the metal particles is half of an area of the plurality of first regions.

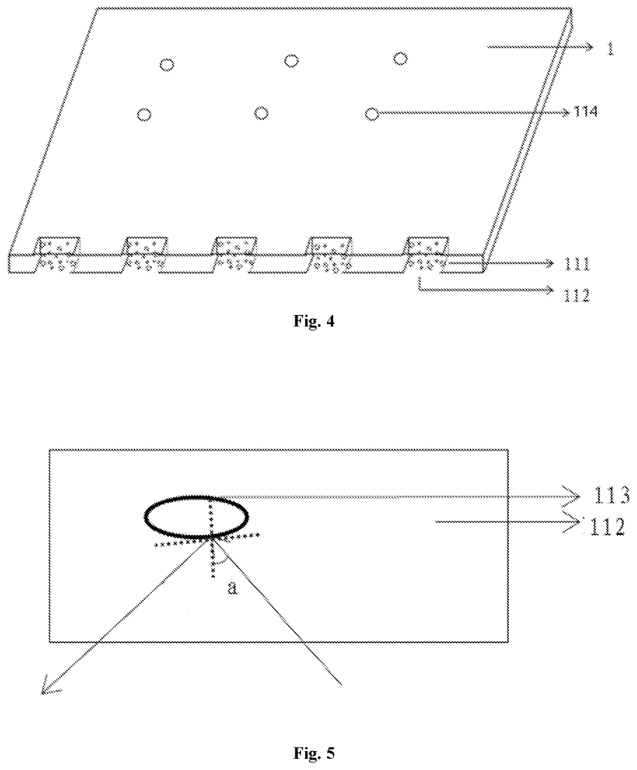

As shown in FIG. 4, in some embodiments of the present disclosure, the first optical structure 11 includes a groove 111 provided in the plurality of first regions, and the groove is filled with a transparent filler 112 having air bubbles therein.

In the case that light is incident from an optically denser medium on the surface of an optically thinner medium, when the incident angle a is greater than a critical value, the light is totally reflected; and when the incident angle a is less than the critical value, the light is refracted. As shown in FIG. 5, the refractive index of air is 1, and a material having a refractive index greater than 1 is selected to prepare the transparent filler. After the light emitted by the light source 21 passes through the transparent filler 112 including the air bubbles 113, the light having an incident angle greater than the critical value will be totally reflected to the lamp bar 2; and the light having an incident angle smaller than the critical value is partially refracted into the light guide plate 1 and partially reflected. The light reflected by the transparent filler is reflected back to the light guide plate 1 by the second optical structure 22 and the reflective layer of the light source 21, and other part of the light directly enters the light guide plate 1. As a result, a transflective effect is achieved.

In some embodiments of the present disclosure, a material of the transparent filler is polyethylene terephthalate (PET), polymethyl methacrylate (PMMA), or methyl methacrylate (MS).

In the above embodiments of the present disclosure, the number of air bubbles in the transparent filler and the shape of the air bubbles are set according to actual needs.

In some embodiments of the present disclosure, a light exiting surface of the light guide plate is arranged adjacent to the light entering surface, and a side surface of the light guide plate 1 arranged opposite to the light exiting surface includes grid points 114, in which the grid points 114 are configured to scatter light.

The arrangement of the grid points 114 enables the light to enter the light guide plate 1 to be uniformly emitted from the light exiting surface of the light guide plate 1, thereby improving the product quality.

Some embodiments of the present disclosure provide a display device including any one of the backlight modules described above.

The display device in the above embodiment of the present disclosure reduces the difference in the brightness between different regions of the light entering surface of the light guide plate 1 through the arrangement of the first optical structure 11 and the second optical structure 22 and thus avoid the hotspot phenomenon without increasing the number of LEDs; and as for the narrow frame products, it simplifies the structure of the display device as compared with the manner of increasing the number of LEDs and arranging multiple diffusion sheets in the related art, and avoids the occurrence of the hotspot phenomenon.

The above descriptions are some embodiments of the present disclosure. It should be noted that a person skilled in the art would make several improvements and substitutions without departing from the principles of the present disclosure.

1. A backlight module, comprising a light guide plate and a lamp bar arranged on a light entering surface of the light guide plate, wherein the lamp bar comprises a circuit board and a plurality alight sources arranged at intervals on the circuit board, the light entering surface of the light guide plate comprises a plurality of first regions and a plurality of second regions each located between two adjacent first regions, and the plurality of first regions is directly opposite to the plurality of light sources respectively, wherein
each of the plurality of first regions comprises a first optical structure, the first optical structure being configured to enable a part of light emitted by a corresponding light source to enter an inside of the light guide plate and reflect a part of light emitted by a corresponding light source to the lamp bar; and
the circuit board comprises a second optical structure located between two adjacent light sources, the second optical structure being configured to reflect light reaching the second optical structure back to the light entering surface of the light guide plate.

2. The backlight module of claim 1, wherein the second optical structure comprises a diffusion layer, and the diffusion layer is configured to scatter the light reaching the second optical structure.

3. The backlight module of claim 2, wherein the diffusion layer comprises scattering particles arranged on the circuit board.

4. The backlight module of claim 1, wherein each of the plurality of light sources comprises a light emitting diode (LED) lamp and a packaging layer covering an outside of the LED lamp, and an outside of the packaging layer comprises a reflective layer configured to reflect light reaching the plurality of light sources back to the light guide plate.

5. The backlight module of claim 1, wherein the first optical structure is a metal film layer, and the metal film layer covers a part of each of the plurality of first regions.

6. The backlight module of claim 5, wherein an area of the plurality of first regions covered by the metal film layer is half of an area of the plurality of first regions.

7. The backlight module of claim 1, wherein the first optical structure comprises metal particles distributed at intervals between the two adjacent first regions.

8. (canceled)

9. The backlight module of claim 7, wherein a material of the metal particles is aluminum or silver.

10. The backlight module of claim 7, wherein an area of the plurality of first regions covered by the metal particles is half of an area of the plurality of first regions.

11. The backlight module of claim 1, wherein the first optical structure comprises a groove arranged in the plurality of first regions and a transparent filler, wherein the transparent filler is filled inside the groove and has air bubbles.

12. The backlight module of claim 11, wherein a material of the transparent filler is polyethylene terephthalate (PET), polymethyl methacrylate (PMMA), or methyl methacrylate (MS).

13. The backlight module of claim 1, wherein a light exiting surface of the light guide plate is arranged adjacent to the light entering surface, and a side surface of the light guide plate arranged opposite to the light exiting surface comprises grid points, wherein the grid points are configured to scatter light.

14. A display device comprising the backlight module of claim 1.

15. The display device of claim 14, wherein the second optical structure comprises a diffusion layer, and the diffusion layer is configured to scatter the light reaching the second optical structure.

16. The display device of claim 14, wherein each of the plurality of light sources comprises a light emitting diode (LED) lamp and a packaging layer covering an outside of the LED lamp, and an outside of the packaging layer comprises a reflective layer configured to reflect light reaching the plurality of light sources hack to the light guide plate.

17. The display device of claim 14, wherein the first optical structure is a metal film layer, and the metal film layer covers a part of each of the plurality of first regions.

18. The display device of claim 17, wherein an area of the plurality of first regions covered by the metal film layer is half of an area of the plurality of first regions.

19. The display device of claim 14, wherein the first optical structure comprises metal particles distributed at intervals between the two adjacent first regions.

20. The display device of claim 19, wherein an area of the plurality of first regions covered by the metal particles is half of an area of the plurality of first regions.

21. The display device of claim 14, wherein the first optical structure comprises a groove arranged in the plurality of first regions and a transparent filler, wherein the transparent filler is filled inside the groove and has air bubbles.
